(19) United States
(12) Patent Application Publication
(10) Pub. No.: US 2012/0001017 A1
(43) Pub. Date: Jan. 5, 2012

(54) INSTALLATION PLATFORM FOR DEPLOYING AN EARTH-BASED SENSOR NETWORK UTILIZING A PROJECTED PATTERN FROM A HEIGHT

(76) Inventors: John Paul STRACHAN, Millbrae, CA (US); Wei Yi, Mountain View, CA (US); Jianhua Yang, Palo Alto, CA (US)

(21) Appl. No.: 12/830,183

(22) Filed: Jul. 2, 2010

(51) Int. Cl. B64B 1/00

(52) U.S. Cl. 244/24

(57) ABSTRACT

An installation platform for deploying an earth-based sensor network utilizing a projected pattern from a height. The installation platform includes an aerostatic aircraft, at least one sensor-location projector, and a projector stabilizer. The sensor-location projector is coupled with the aerostatic aircraft, and is configurable to project the projected pattern including at least one sensor-location marker associated with a location for a sensor in the sensor network. The projector stabilizer is configurable for maintaining the sensor-location projector in a sufficiently static orientation relative to the location for the sensor to allow deployment of the sensor within a specified distance of the location on a surface of the earth from the sensor-location marker. A sensor-network-deployment system along with a method for deploying the sensor-network are also provided.

### CROSS-REFERENCE TO RELATED APPLICATIONS

This application is related to commonly assigned patent applications: U.S. patent application Ser. No. 12/790,970, filed May 31, 2010, entitled, “Node Placement Apparatus, System and Method;” International Application No. PCT/US10/33,236, filed Apr. 30, 2010, entitled, “Aerostatic Platform for Monitoring an Earth-Based Sensor Network;” and, U.S. patent application Ser. No. 12/770,941, filed Apr. 30, 2010, entitled, “Sensor-Location System for Locating a Sensor in a Tract Covered by an Earth-Based Sensor Network.”

### TECHNICAL FIELD

Embodiments of the present invention relate generally to an installation platform and a sensor-network-deployment system for deploying an earth-based sensor network, and a method for deploying the earth-based sensor-network.

### BACKGROUND

As the demand for resources increases with the growth of human populations, interest in developing new methodologies for the discovery and exploitation of these resources continues to grow. For example, with the emergence of increasing demand for petroleum products from rapidly developing countries, the impetus to find new reserves of oil has taken a pre-eminent role in the global economy. Moreover, increasing global populations have placed greater demands on securing the borders of countries in proximity to large populations displaced by economic stressors affecting their less fortunate neighbors. In addition, the growth of human populations along with increasing polarizations within such populations has raised the specter of terrorist assaults affecting domestic tranquility within sovereign territories. All the above, suggest applications that may profit from methodologies for monitoring large tracts of land with sensor networks.

Thus, scientists are engaged in developing new methodologies for the deployment of diverse sensor networks on the surface of the earth, whether those sensors, for example, are directed towards the discovery of new mineral resources, or towards the defense of countries from emerging threats to their security.

### DESCRIPTION OF THE DRAWINGS

The accompanying drawings, which are incorporated in and form a part of this specification, illustrate embodiments of the invention and, together with the description, serve to explain the embodiments of the invention:

FIG. 1 is a perspective view of locations of: a projected pattern from a height for the deployment of sensors in an earth-based sensor network, sensor-location markers of the projected pattern for sensors in the earth-based sensor network, sensor-location projectors above the earth-based sensor network, and restraints for fixing a sensor-location projector above the earth-based sensor network, in accordance with embodiments of the present invention.

FIG. 2 is a perspective view of the earth-based sensor network and an installation platform for deploying the earth-based sensor network, in accordance with embodiments of the present invention.

FIG. 3 is a perspective view of an alternative aircraft-position stabilizer utilizing restraints for fixing a sensor-location projector of the installation platform above the earth-based sensor network, in accordance with embodiments of the present invention.

FIG. 4 is a perspective view of a sensor-network-deployment system including a plurality of installation platforms for deploying an earth-based sensor network, in accordance with embodiments of the present invention.

FIG. 5 is another perspective view of the sensor-network-deployment system showing a plurality of installation platforms emitting electromagnetic waves from the sensor-location projectors of respective installation platforms to produce a projected pattern of sensor-location markers for detection by a sensor-location-marker detector to signal a deployer, when the sensor is positioned in close proximity to the location for the sensor, in accordance with embodiments of the present invention.

FIG. 6 is a flowchart of a method for deploying the earth-based sensor network utilizing the projected pattern from a height, in accordance with embodiments of the present invention.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

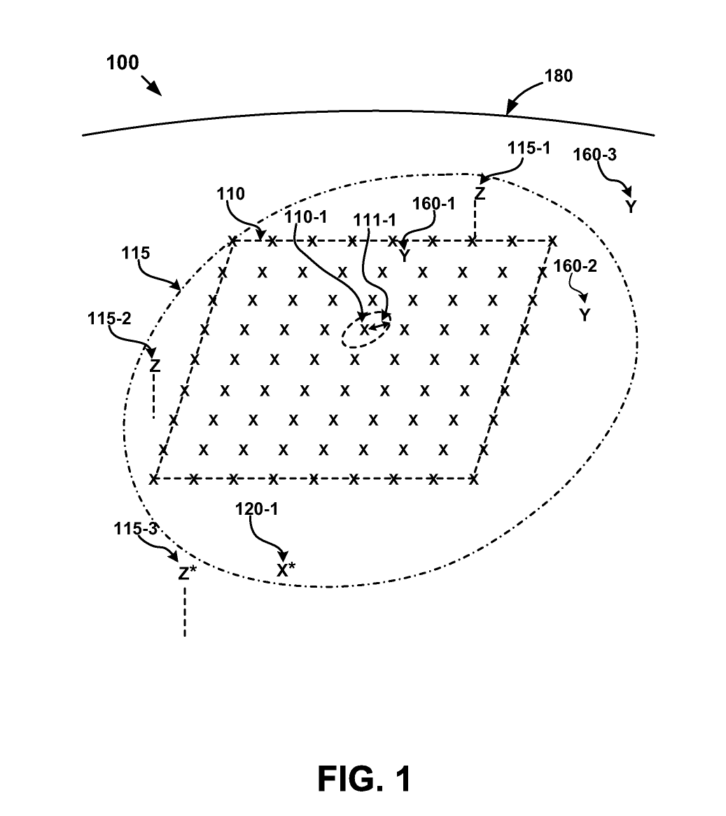

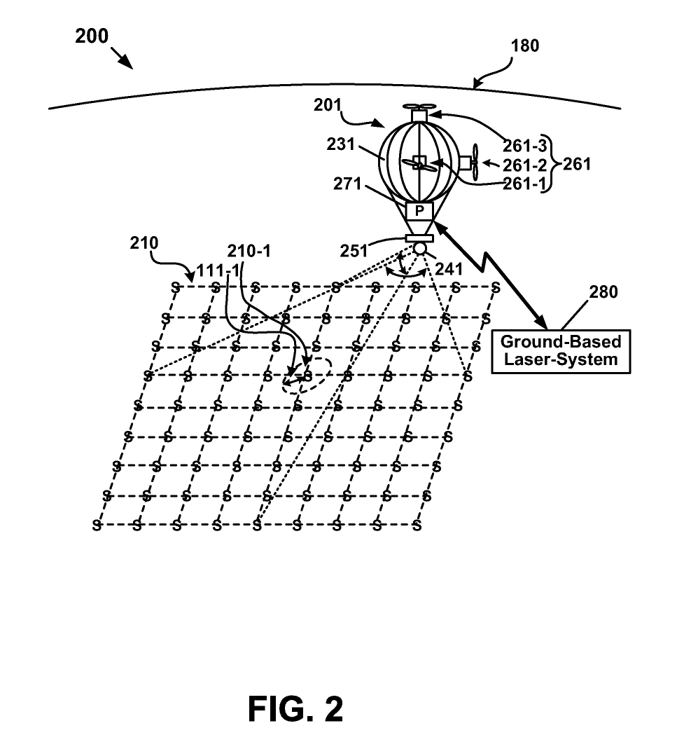

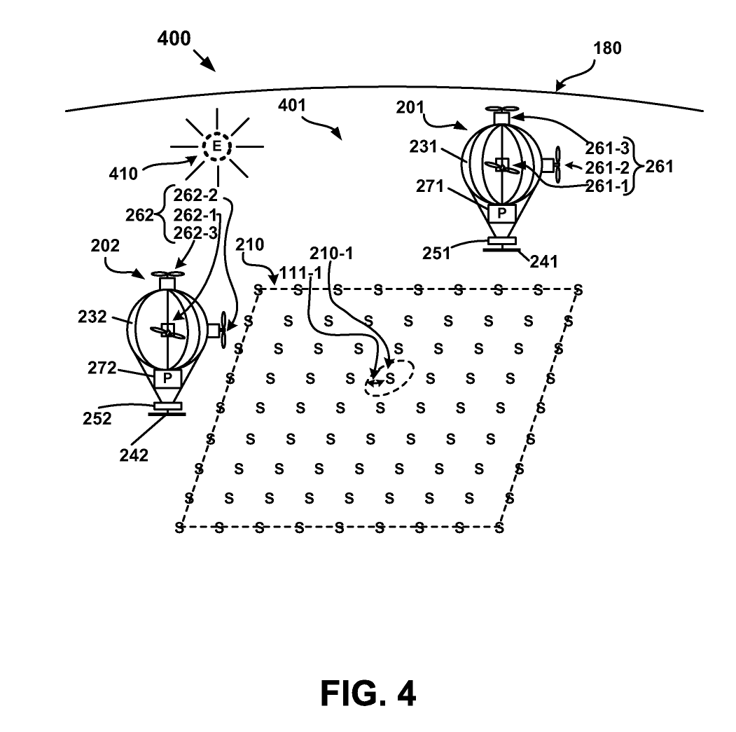

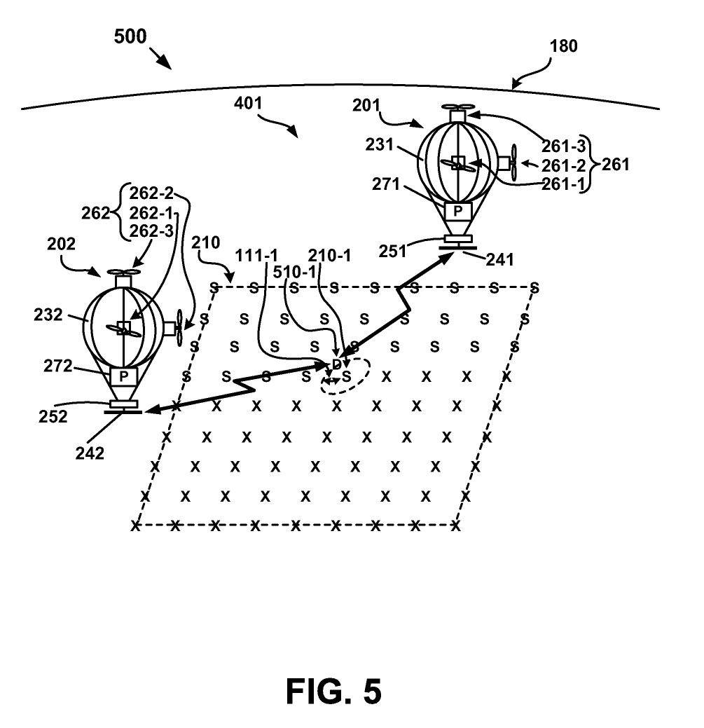

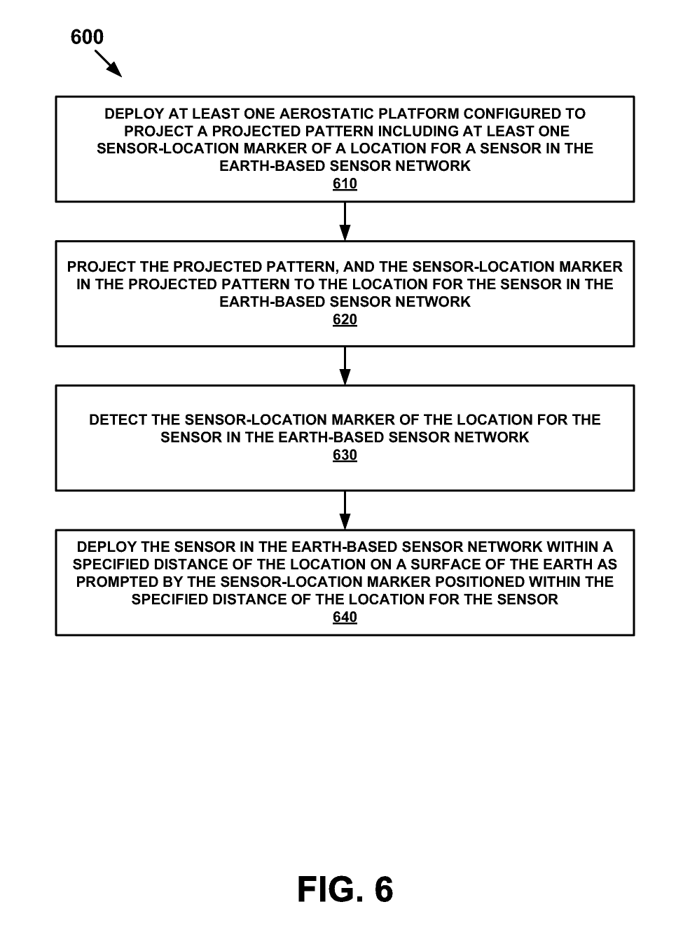

Embodiments of the present invention include an installation platform for deploying an earth-based sensor network utilizing a projected pattern from a height (see FIGS. 1 and 2). The installation platform includes an aerostatic aircraft, at least one sensor-location projector, and a projector stabilizer. The sensor-location projector is coupled with the aerostatic aircraft, and is configurable to project the projected pattern including at least one sensor-location marker associated with a location for a sensor in the earth-based sensor network. The projector stabilizer is configurable for maintaining the sensor-location projector in a sufficiently static orientation relative to the location for the sensor in the earth-based sensor network to allow deployment of the sensor within a specified distance of the location on a surface of the earth from the sensor-location marker positioned within the specified distance of the location for the sensor. A sensor-network-deployment system is also provided (see FIGS. 4 and 5), along with a method (see FIG. 6) for deploying the earth-based sensor-network utilizing a projected pattern from a height.

With reference now to FIGS. 2, 3, 4 and 5, and in particular to FIG. 1, in accordance with embodiments of the present invention, a perspective view 100 is shown in FIG. 1 relevant to the subsequent description of the geometrical arrangement of various components in embodiments of the present invention, described in the discussion of FIGS. 2-5. FIG. 1 shows the surface of the earth 180, as delineated by the horizon, and locations for deployment with respect to the surface of the earth 180 of the following components, shown deployed at these locations in FIG. 2: the earth-based sensor network 210; sensors, for example, sensor 210-1, in the earth-based sensor network 210; sensor-location projectors, of which sensor-location projector 241 is an example, above the earth-based sensor network 210; and restraints, for example, restraints 255-1, 255-2 and 255-3, for fixing an aerostatic aircraft, for example, aerostatic aircraft 231, above the earth-based sensor network 210. As shown in FIGS. 1 and 2, in accordance with an embodiment of the present invention, a projected pattern 110 of sensor-location markers for sensors in the earth-based sensor network 210 includes an arrangement of a plurality of locations of sensors, indicated by a sensor-location marker, “X,” at each location of a sensor, for example, location 110-1 of sensor 210-1, with respect to the surface of the earth 180. By way of example, the array of sensors of the projected pattern 110 of sensor-location markers appears to be arranged in a grid pattern, without limitation thereto; but, other geometrical arrangements for the deployment of sensors within the earth-based sensor network 210 are within the spirit and scope of embodiments of the present invention. For example, even though the array of sensors of the projected pattern 110 of sensor-location markers appears to be arranged in a regular geometrical pattern, for example, the grid pattern shown in FIG. 1, a plurality of sensors arranged in an irregular array, for example, in which the sensors are randomly displaced from the locations in the grid pattern and along directions at random angular orientations relative to lines in the grid pattern as shown, as well as displaced above and below a plane of the grid pattern, is also within the spirit and scope of embodiments of the present invention. Thus, in accordance with embodiments of the present invention, the array of sensors of the projected pattern 110 of sensor-location markers may be quite irregular, as is likely to be the case for deployments in rough terrain, which makes embodiments of the present invention that provide for deploying the sensors with accuracy quite useful. For sensors arrayed in a square-grid projected pattern, similar to the projected pattern 110 of sensor-location markers shown in FIG. 1, the dimensions of the earth-based sensor network may be about 10 kilometers (km) on each side, with about one million, 1×10⁶, sensors arranged in a square-grid pattern; in such a pattern, the sensors may be spaced about every 10 meters (m) from the next adjacent sensor in two orthogonal directions. Embodiments of the present invention are directed towards a rapid means for deployment of sensors in the earth-based sensor network, such as, for example, earth-based sensor network 210 based on the projected pattern 110 of sensor-location markers. Embodiments of the present invention also provide an alternative to other techniques of sensor deployment known in the art, such as, for example, the use of sensor-location projector towers, or alternatively, poles, to deploy the sensors, which involves considerable overhead in erecting a tower, or alternatively, the use of trucks dragging lines of sensors onto an area of interest to deploy the sensors, which is subject to uncertainties in sensor location on rough terrains. Embodiments of the present invention also refer to an “earth-based” sensor network 210, because sensors may be deployed on various types of tracts on the surface of the earth, without limitation to terrestrial terrains.

With further reference to FIGS. 1-5 and in particular to FIGS. 1 and 2, in accordance with another embodiment of the present invention, a deployment plan 115 for fixing sensor-location projectors, for example, sensor-location projectors 241 and 242, of a plurality of at least two aerostatic aircraft, for example, aerostatic aircraft 231 and 232, includes an arrangement of a plurality of locations, for example, aerial locations 115-1 and 115-2, of sensor-location projectors, indicated by a “Z” at each location of an sensor-location projector above the surface of the earth 180. Moreover, in accordance with a further embodiment of the present invention, a plurality of at least three non-collinear points, for example, non-collinear points 160-1, 160-2, 160-3, may be provided for tethering each aerostatic aircraft, of which aerostatic aircraft 231 is an example, with at least three restraints 255-1, 255-2, 255-3, respectively, with an earth-fixed end of a restraint, for example, restraint 255-1, attached to the earth 180 at one point, for example, point 160-1, indicated by a “Y” at each location of an earth-fixed end of a restraint affixed to the surface of the earth 180; no two earth-fixed ends of the restraints are affixed at the same point, for example, point 160-1, without limitation thereto. Also shown in FIG. 1, in accordance with an embodiment of the present invention, another aerostatic and fixed aerial location, for example, aerial location 115-3, associated with deployment of another installation platform for deploying the earth-based sensor network 210 is provided, indicated by a “Z*” at a deployment location of an sensor-location projector above the surface of the earth 180, as might be used in “stitching” adjacent projected patterns of sensor-location markers together, in extending the earth-based sensor network 210 beyond the region shown in FIGS. 1 and 2, for example. As used herein, “stitching” is a term of art that refers to combining two or more projected patterns into a single larger projected pattern with well-defined locations for the deployment of sensors in an earth-based sensor network larger than the earth-based sensor networks associated with each projected pattern combined to form the larger projected pattern. Similarly, in another embodiment of the present invention, a location for deployment of another sensor of an adjacent projected pattern, for example, similar to sensor 210-1 of projected pattern 110 of sensor-location markers, with respect to the surface of the earth 180, for example, at location 120-1, is indicated by the sensor-location marker, “X*,” in FIG. 1.

With reference now to FIG. 2 and further reference to FIG. 1, in accordance with embodiments of the present invention, a perspective view 200 is shown of the installation platform 201 for deploying an earth-based sensor network 210. In accordance with embodiments of the present invention, the installation platform 201 for deploying an earth-based sensor network 210 includes the aerostatic aircraft 231, at least one sensor-location projector 241 coupled with the aerostatic aircraft 231, and a projector stabilizer 251. By way of example, the installation platform 201 is shown in FIG. 2 as including a single sensor-location projector 241; however, more than the single sensor-location projector 241 shown may be suspended from the aerostatic aircraft 231, as an installation platform 201 including a plurality of sensor-location projectors is also within the spirit and scope of embodiments of the present invention. In accordance with embodiments of the present invention, the sensor-location projector may be configured to project a sensor-location marker associated with a location 110-1 for a sensor 210-1 in the earth-based sensor network 210. Whether a single sensor-location projector 241, or a plurality of sensor-location projectors is coupled with the aerostatic aircraft 231, such sensor-location projector 241, or sensor-location projectors, may be secured to the aerostatic aircraft with means for maintaining the sensor-location projector 241, or sensor-location projectors, in a sufficiently static orientation relative to the sensor 210-1 in the earth-based sensor network 210 to allow deployment of the sensor 210-1 within the specified distance 111-1 of the location 110-1 on a surface of the earth 180 from a sensor-location marker positioned within the specified distance 111-1 of the location 110-1 for the sensor 210-1. In accordance with embodiments of the present invention, the specified distance is less than about 10 centimeters. In addition, in accordance with embodiments of the present invention, such means may include a projector stabilizer 251 that may be configured for maintaining the sensor-location projector 241 in a sufficiently static orientation relative to the location 110-1 for the sensor 210-1 in the earth-based sensor network 210. The sensor-location projector 241 may be secured to the aerostatic aircraft 231 with cables and lines, without limitation thereto, that may be configured to rigidly couple the sensor-location projector 241, or sensor-location projectors, to the aerostatic aircraft 231. In accordance with embodiments of the present invention, the aerostatic aircraft 231 may include a balloon, without limitation thereto, as other aerostats such as blimps, air-ships, and other lighter-than-air and buoyant aircraft are also within the spirit and scope of embodiments of the present invention. Moreover, in another embodiment of the present invention, the aerostatic aircraft 231 may include an aircraft selected from the group consisting of a balloon, a zeppelin, a helicopter, a hover-craft, and an aircraft capable of maintaining an aerostatic and fixed aerial location, for example, similar and proximate to aerial location 115-1 for the sensor-location projector 241, above the earth-based sensor network 210. In accordance with embodiments of the present invention, the sensor-location projector 241 may be configured to project a sensor-location marker associated with a location for a sensor 210-1 in the earth-based sensor network 210. As shown in FIG. 2, by way of example, the earth-based sensor network 210 includes a plurality of sensors, each sensor of which is indicated by the letter “S”, which are located at the plurality of locations of sensors, indicated by the sensor-location marker, “X,” in FIG. 1, without limitation thereto. In accordance with embodiments of the present invention, the projector stabilizer 251 may be configured for maintaining the sensor-location projector 241 in a sufficiently static orientation relative to the location 110-1 for the sensor 210-1 in the earth-based sensor network 210 to allow deployment of the sensor 210-1 within the specified distance 111-1 of the location 110-1 on a surface of the earth 180 from a sensor-location marker positioned within a specified distance 111-1 of the location 110-1 for the sensor 210-1. In one embodiment of the present invention, the sensor-location projector includes a laser; and, a wavelength of the laser is such that there is minimal scattering and absorption in the atmosphere over a distance of at least several hundred meters, for example, for an installation platform 201 positioned greater than about 100 meters (m) above the earth-based sensor network 210. Thus, in accordance with embodiments of the present invention, the disposition of the installation platform 201 at a height greater than about 100 m provides for the deployment of sensors in a large array, as in an earth-based sensor network occupying several square kilometers (km²). In another embodiment of the present invention, the sensor-location projector 241 may be configured to project a plurality of sensor-location markers for the sensors in the earth-based sensor network 210 to permit the deployment of the sensors in parallel, rather than in a serial fashion, such that the sensor-location markers are projected to a plurality of locations, of which location 110-1 is an example, essentially simultaneously, rather than sequentially; this provides for rapid deployment of sensors in the earth-based sensor network 210.

With further reference to FIGS. 1 and 2, in one embodiment of the present invention, the projector stabilizer 251 includes a three-axis gyroscope, a motor controller, and a plurality of motors; the motor controller is configured to receive position and orientation information with respect to the aerial location 115-1 and orientation of the sensor-location projector 241 from the gyroscope; and, the plurality of motors is disposed on the sensor-location projector 241 and may be configured to maintain the sensor-location projector 241 sufficiently well-aligned to project a sensor-location marker associated with a location 110-1 for a sensor 210-1 in the earth-based sensor network 210 in response to control signals output from the motor controller to the plurality of motors in response to the position and orientation information received by the motor controller from the gyroscope. Alternatively, in another embodiment of the present invention, a digital compass may be used instead of a gyroscope to provide a position referencing function in the projector stabilizer for the sensor-location projector 241. In another embodiment of the present invention, the projector stabilizer 251 may include a ground-based laser system 280, a motor controller, and a plurality of motors; the motor controller is configured to receive position and orientation information with respect to the aerial location 115-1 and orientation of the sensor-location projector from the ground-based laser system 280; and, the plurality of motors is similarly disposed on the sensor-location projector 241 and may be configured to maintain the sensor-location projector 241 sufficiently well-aligned to project a sensor-location marker associated with a location 110-1 for a sensor 210-1 in the earth-based sensor network 210 in response to a control signals output from the motor controller to the plurality of motors in response to the position and orientation information received by the motor controller from the ground-based laser system 280. The embodiments of the present invention described in the above paragraph provide for accurate deployment of a sensor in proximity to a sensor location designated by a respective sensor-location marker.

With further reference to FIGS. 1 and 2, in one embodiment of the present invention, the installation platform further includes an aircraft-position stabilizer; the aircraft-position stabilizer may be configured for fixing the aerostatic aircraft 231 in an aerostatic and fixed aerial location, for example, similar and proximate to aerial location 115-1 for the sensor-location projector 241, above the earth-based sensor network 210, and for maintaining the sensor-location projector 241 in a sufficiently stationary position relative to the location 110-1 for the sensor 210-1 in the earth-based sensor network 210 to allow deployment of the sensor 210-1 within the specified distance 111-1 of the location 110-1 on a surface of the earth from a sensor-location marker positioned within the specified distance 111-1 of the location 110-1 for the sensor 210-1. In another embodiment of the present invention, the aircraft-position stabilizer provides an aerial position control system. In accordance with an embodiment of the present invention, the aircraft-position stabilizer includes a ground-based laser system, for example, similar to the ground-based laser system 280 for the sensor-location projector 241, a thruster controller, and a plurality of thrusters; the thruster controller is configured to receive position information with respect to the aerial location of the aerostatic aircraft from the ground-based laser system; and, the plurality 261 of thrusters, for example, shown as propellers 261-1, 261-2 and 261-3 without limitation thereto, is disposed on the aerostatic aircraft 231, and may be configured to maintain the aerostatic aircraft 231 in sufficient proximity to the aerial location in response to positional control signals output from the thruster controller to the plurality 261 of thrusters, for example, shown as propellers 261-1, 261-2 and 261-3, in response to the position information received by the thruster controller. As shown in FIG. 2, the plurality 261 of thrusters, for example, propellers 261-1, 261-2 and 261-3 without limitation thereto, is disposed on the aerostatic aircraft 231 to provide translational stability in three dimensions, for example, three orthogonal directions given by an x-coordinate, a y-coordinate, and a z-coordinate, without limitation thereto, for the aerostatic aircraft to which the sensor-location projector 241 is affixed above the earth-based sensor network 210. As shown in FIG. 2, the mutual orthogonality of the propellers 261-1, 261-2 and 261-3 is suggested by the disposition of the propellers 261-1, 261-2 and 261-3 at three orthogonal locations on the balloon shown as the aerostatic aircraft 231, for schematic purposes only, without limitation thereto, as other arrangements are within the spirit and scope of embodiments of the present invention; for example, the thruster corresponding to the top-mounted propeller 261-3 might be provided for by a burner of a hot-air balloon; and likewise, the thrusters, for example, propellers 261-1 and 261-2, might be provided by out-board engines as are employed for a dirigible. Similarly, the plurality of motors that is disposed on the sensor-location projector 241 may be configured to provide translational stability in three dimensions, for example, three orthogonal directions given by an x-coordinate, a y-coordinate, and a z-coordinate, without limitation thereto, for the sensor-location projector 241 above the earth-based sensor network 210. Moreover, the plurality of motors that is disposed on the sensor-location projector 241 may be configured to provide orientational stability in three dimensions, for example, three orthogonal directions given by three direction cosines with respect to each of three orthogonal vectors in an x-direction, a y-direction, and a z-direction, without limitation thereto, for the direction of projection of a sensor-location marker from the sensor-location projector 241 above the earth-based sensor network 210.

With further reference to FIGS. 1 and 2, in accordance with embodiments of the present invention, a sensor-location projector 241 including a laser may be configured to scan a laser beam along a row in which the sensor 210-1 is to be located, as indicated by the dotted lines extending from the sensor-location projector 241 to the ends of the row of the sensor 210-1, and to scan a laser beam along a column in which the sensor 210-1 is to be located, as indicated by the dotted lines extending from the sensor-location projector 241 to the ends of the column of the sensor 210-1; in one embodiment of the present invention, the sensor-location marker of sensor 210-1 may include the crossing point of the laser beams scanned along the column and the row of the sensor 210-1. Thus, in accordance with embodiments of the present invention, the dashed lines shown in FIG. 2 corresponding to the rows and columns of sensors in the earth-based sensor network 210 include a rectangular grid pattern that guides the installation of sensors at the crossing points of the rows and columns, without limitation thereto. As shown in FIG. 2, the angles between the dotted lines extending from the sensor-location projector 241 to the ends of the column and the row, respectively, of the sensor 210-1 are similar, but not identical, to the elevation angle and azimuthal angle in a spherical coordinate system so that the rectangular grid pattern can be generated by scanning one or more laser beams over each of the columns and rows in the grid pattern. However, other patterns for disposition of the sensors different from a rectangular grid pattern are also within the spirit and scope of embodiments of the present invention; for example, a polar grid pattern may be produced by scanning laser beams along true elevation and azimuthal angles in a spherical coordinate system. Moreover, the sensor-location marker may include a laser beam activated to illuminate just the crossing points corresponding to the locations of sensors of a projected pattern, for example, indicated by the sensor-location markers, “X's,” in the projected pattern 110 of sensor-location markers for sensors of FIG. 1, rather than the rows and columns of the sensors, indicated by the dashed lines in FIG. 2. Thus, in accordance with embodiments of the present invention, the projected pattern may be other than a rectangular grid pattern, as previously discussed. Moreover, other methods of producing a sensor-location marker for a sensor are also within the spirit and scope of embodiments of the present invention, as may be produced by characteristic features, for example, interference maxima and minima, produced by electromagnetic waves emitted from one or more sensor-location projectors that are subsequently described in the discussion of FIG. 5.

With further reference to FIGS. 1 and 2, in accordance with embodiments of the present invention, the installation platform 201 further includes a payload 271 indicated by the letter “P”; the payload 271 may be selected from the group consisting of: a receiver for receiving signals sent to the installation platform 201, for example, signals (denoted by the dark double-headed arrow in FIG. 2) sent from the ground-based laser system 280; a global-positioning system (GPS) receiver, for example, configured to determine a position of the installation platform 201; a differential GPS (DGPS) receiver, for example, configured to determine a position of an installation platform relative to other installation platforms of a plurality of platforms (see FIGS. 4 and 5); a three-axis gyroscope; a motor controller, for example, configured to receive position and orientation information with respect to the aerial location 115-1 and orientation of the sensor-location projector 241 from the gyroscope, or alternatively, from ground-based laser system 280; a thruster controller configured to receive position information with respect to the aerial location of the aerostatic aircraft 231 from the ground-based laser system 280; and combinations of the receiver, GPS receiver, DGPS receiver, gyroscope, motor controller, and thruster controller, without limitation thereto. In accordance with embodiments of the present invention, various elements of the payload may be included in a feedback control system to control and maintain the stability of a projected pattern 110 of sensor-location markers at the locations of sensors, of which location 110-1 of sensor 210-1 is an example. For example, the projector stabilizer may include one such feedback control system. Similarly, the aircraft-position stabilizer including the aerial position control system may include another such feedback control system. Alternatively, the aircraft-position stabilizer may include non-dynamic components, for example, at least three restraints coupled with the aerostatic aircraft 231, which are configured for fixing the aerostatic aircraft 231 in an aerostatic and fixed aerial location, for example, similar and proximate to aerial location 115-1 for the sensor-location projector 241, above the earth-based sensor network 210, and for maintaining the sensor-location projector 241 in a sufficiently stationary position relative to the location 110-1 for the sensor 210-1 in the earth-based sensor network 210 to allow deployment of the sensor 210-1 within the specified distance 111-1 of the location 110-1 on the surface of the earth 180 from a sensor-location marker positioned within the specified distance 111-1 of the location 110-1 for the sensor 210-1, as next described.

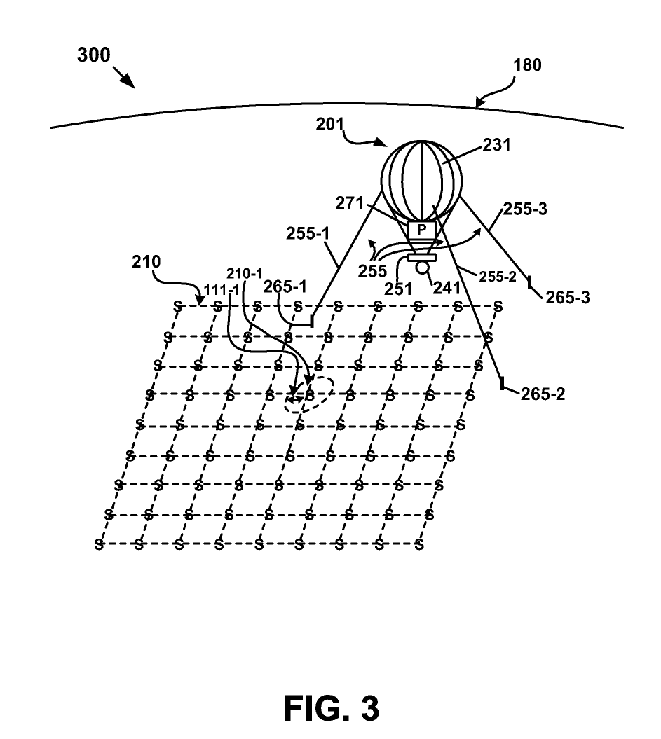

With reference now to FIG. 3 and further reference to FIG. 1, in accordance with alternative embodiments of the present invention, a perspective view 300 is shown of an aircraft-position stabilizer that may include a plurality 255 of restraints for fixing the sensor-location projector 241 of the installation platform 201 above the earth-based sensor network 210. In accordance with one embodiment of the present invention, the plurality 255 of restraints may include at least three restraints 255-1, 255-2 and 255-3 coupled with the aerostatic aircraft 231 at respective ends of the restraints 255-1, 255-2 and 255-3. The other respective ends of the restraints, for example, restraints 255-1, 255-2 and 255-3, are configurable for attachment to the earth 180 at least three non-collinear points 160-1, 160-2 and 160-3 such that no two earth-fixed ends of the restraints are affixed at the same point, without limitation thereto. As shown in FIG. 3, by way of example, stakes 265-1, 265-2 and 265-3 affix the earth-bound ends of the restraints, for example, restraints 255-1, 255-2 and 255-3, to the earth at the points 160-1, 160-2, 160-3, shown in FIG. 1, respectively, without limitation thereto, as other means for affixing the earth-bound ends of the restraints to the earth are also within the spirit and scope of embodiments of the present invention. For example, in one embodiment of the present invention, the earth-bound ends of the restraints may be affixed to motorized utility vehicles that are heavy enough so as not to be buoyed up aloft with the aerostatic aircraft, which are located in proximity to the points 160-1, 160-2, 160-3, such that the earth-bound ends of the restraints are essentially affixed at the points 160-1, 160-2 and 160-3. Any of the restraints 255-1 through 255-3 may be selected from the group consisting of tethering lines, guy wires, ropes, chains, or similar readily deployable and portable restraints, without limitation thereto. In accordance with embodiments of the present invention, the installation platform 201 provides for ease of mobility of the sensor-location projector 241 in contrast with other sensor-location projector support structures, such as towers, or trucks with erectable towers, which may involve tedious assembly and disassembly procedures.

With reference now to FIG. 4 and further reference to FIG. 1, in accordance with embodiments of the present invention, a perspective view 400 is shown of a sensor-network-deployment system 401 showing the sensor 210-1 having been deployed in response to a sensor-location marker produced by a plurality of installation platforms, for example, installation platforms 201 and 202. In accordance with embodiments of the present invention, the sensor-network-deployment system 401 includes a plurality of installation platforms 201 and 202, by way of example without limitation thereto, for deploying an earth-based sensor network 210. In accordance with embodiments of the present invention, each installation platform, for example, one of installation platforms 201 and 202, of the plurality of installation platforms 201 and 202 includes: a respective aerostatic aircraft, for example, one of aerostatic aircrafts 231 and 232; at least one sensor-location projector, for example, one of respective sensor-location projectors 241 and 242, and, a respective projector stabilizer, for example, projector stabilizers 251 and 252, respectively. In accordance with embodiments of the present invention, each respective sensor-location projector, for example, one of respective sensor-location projectors 241 and 242, is coupled with a respective aerostatic aircraft, for example, one of aerostatic aircrafts 231 and 232. In addition, in accordance with embodiments of the present invention, each respective projector stabilizer, for example, one of projector stabilizers 251 and 252, is configured for fixing a respective sensor-location projector, for example, one of respective sensor-location projectors 241 and 242, in a respective aerostatic and fixed aerial location, for example, one of respective aerial locations 115-1 and 115-2, above the earth-based sensor network 210; each respective projector stabilizer is also configured for maintaining the respective sensor-location projector, for example, one of respective sensor-location projectors 241 and 242, in a sufficiently static orientation relative to the sensor 210-1 in the earth-based sensor network 210 to allow deployment of the sensor 210-1 within the specified distance 111-1 of the location 110-1 on a surface of the earth 180 from detection of a projected pattern 110 of electromagnetic waves within the specified distance 111-1 of the location 110-1 for the sensor 210-1.

With further reference to FIGS. 4 and 1, in accordance with embodiments of the present invention, the plurality of installation platforms includes at least two installation platforms, for example, installation platforms 201 and 202, including at least two sensor-location projectors, for example, sensor-location projectors 241 and 242, of the respective installation platforms; and, the electromagnetic waves emitted from the sensor-location projectors of respective installation platforms are configured to produce a projected pattern 110 of sensor-location markers on the surface of the earth 180, of which the sensor-location marker of the location 110-1 for the sensor 210-1 is an example. For example, in one embodiment of the present invention, the electromagnetic waves may include microwaves emitted from sensor-location projectors 241 and 242 that include microwave antennas, figuratively shown as dipoles in FIG. 4; the microwaves may have frequencies between the terahertz (THz) and the gigahertz (GHz) frequency ranges, such that the wavelengths of the corresponding microwaves may be on the order centimeters (cm). Thus, in one embodiment of the present invention, the electromagnetic waves may be configured to produce interference patterns with characteristic features, for example, interference maxima and/or minima, that may serve as sensor-location markers to allow deployment of the sensor 210-1 within the specified distance 111-1 of the location 110-1 on a surface of the earth 180 within a specified distance 111-1 of, for example, on the order of about at most a few centimeters, of the location 110-1 for the sensor 210-1. Moreover, in another embodiment of the present invention, the sensor-network-deployment system 401 may further include a sensor-location-marker detector configured to signal a deployer 510-1 (indicated by “D” in FIG. 5) of a sensor, for example, sensor 210-1, of the earth-based sensor network 210, when the sensor is positioned in close proximity to, for example, within the specified distance 111-1 of, the location, for example, location 110-1, on the surface of the earth 180; and, the sensor-location marker includes a characteristic feature, for example, an interference maxima and/or minima, without limitation thereto, produced by the electromagnetic waves emitted from the sensor-location projectors, for example, sensor-location projectors 241 and 242, of respective installation platforms, for example, installation platforms 201 and 202. In accordance with embodiments of the present invention, the sensor-location-marker detector may include a detection device selected from the group consisting of: a fluorescent blanket, for example, configured to fluoresce in response to the characteristic feature of the projected pattern 110 associated with the intensity of standing electromagnetic waves produced by an interference pattern; a fluorescent glove, for example, similarly configured to fluoresce in response to the characteristic feature of the projected pattern 110 associated with the intensity of standing electromagnetic waves produced by an interference pattern, which may be worn by the deployer 510-1 of sensors in the earth-based sensor network 210; a glove integrated with a electromagnetic radiation detector, for example, configured to be worn by a deployer of sensors in the earth-based sensor network 210 and to signal, for example, with an audible tone, without limitation thereto, the deployer 510-1 in response to the characteristic feature of the projected pattern 110 associated with the intensity of electromagnetic waves produced by the sensor-location projectors 241 and 242. In accordance with embodiments of the present invention, the intensity of electromagnetic radiation produced by the sensor-location projectors 241 and 242 is expected to be not significantly greater than, or even less than, the intensity of electromagnetic radiation emitted by wireless communication devices, of which a cellular phone is an example.

With further reference to FIGS. 3, 4 and 1, in accordance with an alternative embodiment of the present invention, each installation platform, for example, installation platforms 201 and 202, in the sensor-network-deployment system 401 may include an aircraft-position stabilizer including a plurality of restraints, for example, similar to the plurality 255 of restraints 255-1, 255-2 and 255-3 shown in FIG. 3; moreover, each aircraft-position stabilizer may be configured for fixing each aerostatic aircraft in an aerostatic and fixed aerial location above the earth-based sensor network 210, and for maintaining each sensor-location projector in a sufficiently stationary position relative to the location, for example, location 110-1, for the sensor, for example, sensor 210-1, in the earth-based sensor network 210 to allow deployment of the sensor within the specified distance 111-1 of the location on a surface of the earth 180 from a sensor-location marker positioned within the specified distance 111-1 of the location for the sensor. Thus, in accordance with embodiments of the present invention, to restrain the sensor-location projectors 241 and 242 attached to their respective aerostatic aircraft 231 and 232, pluralities of at least three respective restraints may be coupled with the respective aerostatic aircraft 231 and 232 at respective pluralities of ends of the restraints. The other respective ends of the restraints, for example, similar to restraints 255-1, 255-2 and 255-3 as shown in FIG. 3, respectively, may be configured for attachment to the earth 180 at three pluralities of three non-collinear points, such that no two earth-fixed ends of the restraints is affixed at the same point.

With further reference now to FIGS. 4, 2 and 1, in accordance with embodiments of the present invention, each of the installation platforms 201 and 202 further includes a respective payload 271 and 272 indicated by the letter “P”; each of the payloads 271 and 272 may be selected from the group consisting of: a receiver for receiving signals sent to the installation platform 201, for example, signals (denoted by the dark double-headed arrow in FIG. 2) sent from the ground-based laser system 280; a GPS receiver, for example, configured to determine a position of the installation platform 201; a DGPS receiver, for example, configured to determine a position of an installation platform relative to other installation platforms of a plurality of platforms (see FIGS. 4 and 5); a three-axis gyroscope; a motor controller, for example, configured to receive position and orientation information with respect to the aerial location 115-1 and orientation of the sensor-location projector 241 from the gyroscope, or alternatively, from ground-based laser system 280; a thruster controller configured to receive position information with respect to the aerial location of the aerostatic aircraft 231 from the ground-based laser system 280; and combinations of the receiver, GPS receiver, DGPS receiver, gyroscope, motor controller, and thruster controller, without limitation thereto. In accordance with one embodiment of the present invention, if the payloads 271 and 272 of the respective installation platforms 201 and 202 include GPS receivers, the GPS receivers may be configured to provide co-ordinates of the respective aerostatic and fixed aerial locations 115-1 and 115-2 of the respective sensor-location projectors 241 and 242. By way of example, in accordance with embodiments of the present invention, the co-ordinates of the respective aerostatic and fixed aerial locations 115-1 and 115-2 may be used to determine the location 110-1 of the sensor 210-1 on the surface of the earth 180 from the sensor-location marker projected by the plurality of respective sensor-location projectors 241 and 242, without limitation thereto. Thus, in accordance with an embodiment of the present invention, the plurality of installation platforms 201 and 202 includes at least two installation platforms 201 and 202, such that the plurality of installation platforms 201 and 202 are configured to determine the location 110-1 of the sensor 210-1 on the surface of the earth 180 from the sensor-location marker projected by the plurality of respective sensor-location projectors 241 and 242 of the plurality of installation platforms 201 and 202. Alternatively, in accordance with embodiments of the present invention, the location 110-1 of the sensor 210-1 in the earth-based sensor network 210 may also be provided relative to the location of other sensors in the earth-based sensor network 210 without absolute co-ordinates relative to the earth 180. For example, in one embodiment of the present invention, such co-ordinates of location 110-1 of the sensor 210-1 in the earth-based sensor network 210 may be given in relative co-ordinates of other sensors in the earth-based sensor network 210. Thus, in one embodiment of the present invention, if the absolute co-ordinates relative to the earth 180 of one sensor in the earth-based sensor network 210 is determined, the absolute co-ordinates of all the other sensors in the earth-based sensor network 210 may be computed based on the relative co-ordinates of the other sensors in the earth-based sensor network 210 with respect to one or more sensors in the earth-based sensor network 210 for which the absolute co-ordinates relative to the earth 180 are known. Although the sensor-network-deployment system 401 has been described above in terms of a plurality of installation platforms 201 and 202, previously described embodiments of the present invention for the installation platform 201 may be incorporated within the environment of the sensor-network-deployment system 401 for each installation platform of the plurality of installation platforms 201 and 202, without limitation thereto.

With further reference to FIGS. 4 and 1, in accordance with one embodiment of the present invention, the earth-based sensor network 210 may include at least one sensor 210-1 of a plurality of sensors deployed on the surface of the earth 180 with the sensor 210-1 configured to transmit a signal. In one embodiment of the present invention, the earth-based sensor network 210 provides a central nervous system for the earth (CeNSE) that can provide a variety of data from the surface of the earth 180. In one embodiment of the present invention, the plurality of installation platforms 201 and 202 are arranged to provide a direct line-of-sight to sensors in the earth-based sensor network 210 for deployment of a sensor, for example, sensor 210-1, even if the sensor-network-deployment system 401 deploys sensors over rough terrain, or rugged environments, such as, hilly areas in which a direct line-of-sight is provided by the aerostatic aircraft 231 positioned at an elevated location, for example, aerial location 115-1. In an embodiment of the present invention, the earth-based sensor network 210 is configured to provide information about the effects of an event 410 on sensors in the plurality of sensors, of which sensor 210-1 is an example, through transmission of a signal associated with the event 410. For example, through the effects of the event 410 on at least one sensor 210-1 in the earth-based sensor network 210, the signal may provide data about: the event 410, itself; and/or, the effects of the event 410 on the earth. Consequently, in accordance with embodiments of the present invention, the sensor 210-1 may be selected from the group consisting of an accelerometer, a geophone, a seismometer, and a safety sensor.

By way of example, in one embodiment of the present invention, the event 410 may be the artificially produced vibration of a seismic vibrator used to induce vibrations in the earth for reflection seismography, as is used in petroleum exploration. On the other hand, in another embodiment of the present invention, the event 410 might be of natural origin, such as, an earthquake. Thus, in accordance with embodiments of the present invention, the signal transmitted from the sensor 210-1 includes geophysical data, which may be derived from an accelerometer, a geophone, or alternatively, a seismometer, or other geophysical sensor. For example, another geophysical sensor may be a vibration sensor based on a microphone, for example, similar to a geophone, without limitation thereto. By way of further example, with further reference to FIGS. 4 and 1, in accordance with another embodiment of the present invention, the event 410 may be the onset of structural failure of a structure, for example, a bridge. Thus, in accordance with embodiments of the present invention, the signal transmitted from the sensor 210-1 may include safety data, which may be derived from an accelerometer, and/or a safety sensor. For example, more generally, a safety sensor may also include a chemical sensor without limitation thereto; the chemical sensor may be selected from the group consisting of a sensor sensitive to toxins, a sensor sensitive to pollutants, and a sensor sensitive to explosives, without limitation thereto. Moreover, in accordance with another embodiment of the present invention, the sensor-network-deployment system may further include at least one sensor system including the sensor; at least one sensor-support device, for example, a peripheral component, configured to provide a support function for the sensor, and a sensor-system package encapsulating the sensor and at least one sensor-support device; the sensor-support device may be selected from the group consisting of a power supply, a signal receiver, a signal transmitter, and a data-storage unit, without limitation thereto. In accordance with embodiments of the present invention, the signal receiver, the signal transmitter, and the data-storage unit may provide for reception, transmission, and storage of data or information communicated to, or by, the sensor system in the earth-based sensor network. In one embodiment of the present invention, the sensor-support device including the power supply may include solar cells that provide a power source for the sensor and any attached sensor-support devices, such as a signal receiver, a signal transmitter, and a data-storage unit, without limitation thereto.

With reference now to FIG. 5 and further reference to FIGS. 1, 3 and 4, in accordance with other embodiments of the present invention, another perspective view 500 is shown of the sensor-network-deployment system 401 in a partially deployed state. Components of the sensor-network-deployment system 401 labeled with the same reference numerals in FIGS. 1, 2, 4 and 5 are as previously described. FIG. 5 shows installation platforms, for example, installation platforms 201 and 202, projecting a sensor-location marker to the deployer 510-1 (shown as heavy double headed arrows directed from sensor-location projectors 241 and 242 to the deployer 510-1 in FIG. 5) to produce a deployment signal for deployment of the sensor 210-1 at the location 110-1 in the earth-based sensor network 210. In accordance with yet another embodiment of the present invention, the plurality of installation platforms 201 and 202 may be configured to project a projected pattern 110 of sensor-location markers in response to which a sensor-location-marker detector produces a deployment signal sent to the deployer 510-1 of at least one sensor 210-1 of the plurality of sensors of the earth-based sensor network 210 when the sensor 210-1 is positioned in close proximity to the location 110-1 on the surface of the earth 180. In accordance with embodiments of the present invention, the deployer 510-1 may be a person who deploys the sensors of the earth-based sensor network 210 in similar fashion to the manner in which a farm laborer plants seedlings, without limitation thereto, as other types of deployers are also within the spirit and scope of embodiments of the present invention. Alternatively, in accordance with embodiments of the present invention, the deployer 510-1 may be also be a machine that automatically deploys the sensors in response to the projected sensor-location marker, which may be detected by the sensor-location-marker detector as a deployment signal communicated to the machine, and/or automated deployer. In accordance with embodiments of the present invention, sensors, of which sensor 210-1 is an example, in the earth-based sensor network 210 are readily deployable. The above described mode of operation is expected to be especially useful in mineralogical prospecting operations, such as, petroleum exploration. Thus, embodiments of the present invention provide installation platforms that may be deployed in rugged, remote, and/or dynamically changing environments. The method of deploying a sensor, for example, sensor 210-1, in the earth-based sensor network 210 utilizing the sensor-network-deployment system 401, is next described.

With reference now to FIG. 6, in accordance with yet other embodiments of the present invention, a flowchart 600 is shown of a method for deploying an earth-based sensor-network utilizing a projected pattern from a height. The method for deploying the earth-based sensor network includes the following. At 610, at least one installation platform is deployed that is configured to project a projected pattern comprising at least one sensor-location marker of a location for a sensor in the earth-based sensor network. At 620, the projected pattern is projected, and the sensor-location marker is projected to the location for the sensor in the earth-based sensor network. At 630, the sensor-location marker is detected for the location for the sensor in the earth-based sensor network. At 640, the sensor in the earth-based sensor network is deployed within the specified distance of the location on a surface of the earth as prompted by the sensor-location marker positioned within the specified distance of the location for the sensor.

According to the foregoing descriptions, embodiments of the present invention are suitable for rapid deployment of an earth-based sensor network including a large number of sensors, for example, on the order of 1×10⁶, with high accuracy. In addition, the foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It may be intended that the scope of the invention be defined by the claims appended hereto and their equivalents.

What is claimed is:

1. An installation platform for deploying an earth-based sensor network utilizing a projected pattern from a height, said installation platform comprising:
an aerostatic aircraft;
at least one sensor-location projector coupled with said aerostatic aircraft, said sensor-location projector configurable to project from a height said projected pattern comprising at least one sensor-location marker associated with a location for a sensor in said earth-based sensor network; and
a projector stabilizer configurable for maintaining said sensor-location projector in a sufficiently static orientation relative to said location for said sensor in said earth-based sensor network to allow deployment of said sensor within a specified distance of said location on a surface of the earth from said sensor-location marker positioned within said specified distance of said location for said sensor.

2. The installation platform of claim 1, wherein said projector stabilizer comprises:
a three-axis gyroscope;
a motor controller configured to receive position and orientation information with respect to said aerial location and orientation of said sensor-location projector from said gyroscope; and,
a plurality of motors disposed on said sensor-location projector configurable to maintain said sensor-location projector sufficiently well-aligned to project said sensor-location marker associated with a location for said sensor in said earth-based sensor network in response to control signals output from said motor controller to said plurality of motors in response to said position and orientation information received by said motor controller from said gyroscope.

3. The installation platform of claim 1, wherein said projector stabilizer comprises:
a ground-based laser system;
a motor controller configured to receive position and orientation information with respect to said aerial location and orientation of said sensor-location projector from said ground-based laser system; and,
a plurality of motors disposed on said sensor-location projector configurable to maintain said sensor-location projector sufficiently well-aligned to project said sensor-location marker associated with a location for said sensor in said earth-based sensor network in response to control signals output from said motor controller to said plurality of motors in response to said position and orientation information received by said motor controller from said ground-based laser system.

4. The installation platform of claim 1, further comprising:
an aircraft-position stabilizer configurable for fixing said aerostatic aircraft in an aerostatic and fixed aerial location above said earth-based sensor network, and for maintaining said sensor-location projector in a sufficiently stationary position relative to said location for said sensor in said earth-based sensor network to allow deployment of said sensor within a specified distance of said location on a surface of the earth from a sensor-location marker positioned within said specified distance of said location for said sensor.

5. The installation platform of claim 4, wherein said aircraft-position stabilizer comprises at least three restraints coupled with said aerostatic aircraft.

6. The installation platform of claim 4, wherein said aircraft-position stabilizer comprises:
a ground-based laser system;
a thruster controller configured to receive position information with respect to said aerial location of said aerostatic aircraft from said ground-based laser system; and,
a plurality of thrusters disposed on said aerostatic aircraft configurable to maintain said aerostatic aircraft in sufficient proximity to said aerial location in response to positional control signals output from said thruster controller to said plurality of thrusters in response to said position information received by said thruster controller.

7. The installation platform of claim 1, wherein said aerostatic aircraft comprises an aircraft selected from the group consisting of a balloon, a zeppelin, a helicopter, a hover-craft, and an aircraft capable of maintaining an aerostatic and fixed aerial location above said earth-based sensor network.

8. The installation platform of claim 1, wherein said sensor-location projector comprises at least one laser.

9. The installation platform of claim 1, wherein said specified distance is less than about 10 centimeters.

10. A sensor-network-deployment system, comprising:
a plurality of installation platforms for deploying an earth-based sensor network utilizing a projected pattern of electromagnetic waves from a height, an installation platform of said plurality of installation platforms comprising:
an aerostatic aircraft;
at least one sensor-location projector coupled with said aerostatic aircraft, said sensor-location projector configured to emit said electromagnetic waves producing said projected pattern towards a location for a sensor in said earth-based sensor network; and
a projector stabilizer configured to maintain said sensor-location projector in a sufficiently static orientation relative to said location for said sensor in said earth-based sensor network to allow deployment of said sensor within a specified distance of said location on a surface of the earth from detection of said electromagnetic waves within said specified distance of said location for said sensor.

11. The sensor-network-deployment system of claim 10, wherein said plurality of installation platforms comprises:
at least two installation platforms comprising at least two sensor-location projectors of respective installation platforms; and
wherein electromagnetic waves emitted from said sensor-location projectors of respective installation platforms are configured to produce a sensor-location marker in said projected pattern in proximity to said location for said sensor on said surface of said earth.

12. The sensor-network-deployment system of claim 10, further comprising:
a sensor-location-marker detector configured to signal a deployer of at least one sensor of said earth-based sensor network, when said sensor is positioned in close proximity to said location on said surface of said earth; and,
wherein said sensor-location marker comprises a characteristic feature of said projected pattern produced by said electromagnetic waves emitted from said sensor-location projectors of respective installation platforms.

13. The sensor-network-deployment system of claim 12, wherein said sensor-location-marker detector comprises a detection device selected from the group consisting of: a fluorescent blanket configured to fluoresce in response to said characteristic feature of said projected pattern; a fluorescent glove, which may be worn by said deployer of said sensor, configured to fluoresce in response to said characteristic feature of said projected pattern; and, a glove integrated with an electromagnetic radiation detector, which may be worn by said deployer of said sensor, configured to signal said deployer in response to said characteristic feature of said projected pattern.

14. The sensor-network-deployment system of claim 10, further comprising:
at least one sensor system comprising:
said sensor;
at least one sensor-support device configured to provide a support function for said sensor, said sensor-support device selected from the group consisting of a power supply, a signal receiver, a signal transmitter, and a data-storage unit; and
a sensor-system package encapsulating said sensor and at least one said sensor-support device; and
wherein said sensor is selected from the group consisting of an accelerometer, a geophone, a seismometer, a vibration sensor, a chemical sensor, a toxin sensor, a pollutant sensor, an explosive sensor, and a safety sensor.

15. A method for deploying an earth-based sensor network utilizing a projected pattern from a height, said method comprising:
deploying at least one installation platform configured to project a projected pattern comprising at least one sensor-location marker of a location for a sensor in said earth-based sensor network;
projecting said projected pattern, and said sensor-location marker in said projected pattern to said location for said sensor in said earth-based sensor network;
detecting said sensor-location marker of said location for said sensor in said earth-based sensor network; and
deploying said sensor in said earth-based sensor network within a specified distance of said location on a surface of the earth as prompted by said sensor-location marker positioned within said specified distance of said location for said sensor.
